(19) United States
(12) Patent Application Publication
(10) Pub. No.: US 2024/0181508 A1
(43) Pub. Date: Jun. 6, 2024

(54) CONTAMINATION DETECTION DEVICE, AUTOMATIC CLEANING DEVICE, CONTAMINATION DETECTION AND AUTO-CLEANING EQUIPMENT AND METHOD USING THE SAME

(71) Applicant: INDUSTRIAL TECHNOLOGY RESEARCH INSTITUTE, Hsinchu (TW)

(72) Inventors: Chun-Kuo LIU, Hsinchu City (TW); Chen-Hua CHU, Zhubei City (TW); Chi-Fan WANG, Taoyuan City (TW); Yu-Xuan LIN, Yilan City (TW)

(73) Assignee: INDUSTRIAL TECHNOLOGY RESEARCH INSTITUTE, Hsinchu (TW)

(21) Appl. No.: 18/523,396

(22) Filed: Nov. 29, 2023

(30) Foreign Application Priority Data
Dec. 2, 2022 (TW) 111146369
Jun. 15, 2023 (CN) 202310709619.9

(51) Int. Cl. B08B 9/46; B08B 9/08

(52) U.S. Cl. CPC B08B 9/46; B08B 9/0808; B08B 2209/005

(57) ABSTRACT

A contamination detection and auto-cleaning equipment and a method using the same are provided. The contamination detection and auto-cleaning equipment includes a contamination detection device and an automatic cleaning device. The contamination detection device is configured for detecting a cleanliness of a sample container. The automatic cleaning device is configured for cleaning the sample container. The contamination detection device includes a light emitter, a detection-light receiver and a controller. The light emitter is configured for emitting an emission light, wherein the emission light becomes a detection light after traveling through the sample container. The detection-light receiver is configured for receiving the detection light to obtain a detection-light intensity. The controller is coupled to the light emitter and the detection-light receiver, and obtain the cleanliness of the sample container according to a variation of the detection-light intensity.

This application claims the benefit of Taiwan application Serial No. 111146369, filed Dec. 2, 2022, and People's Republic of China application Serial No. 202310709619.9, filed Jun. 15, 2023, the subject matters of which are incorporated herein by references.

### TECHNICAL FIELD

The disclosure relates in general to a contamination detection device, an automatic cleaning device, a contamination detection and auto-cleaning equipment and method using the same.

### BACKGROUND

After a sample container of a conventional water quality detection device is configured for a period of time, contamination (such as dyeing, particle adhesion, biofilm growth, etc.) will inevitably adhere to an inner wall of the sample container, and it will affect a measurement accuracy of the water quality detection device for a test liquid. The test liquid is to be measured.

### SUMMARY

Even if the water quality detection device uses an ultrasonic conduction rod to conduct vibrations in the liquid, or a driving motor drives a cleaning brush to rotate to clean the dirt on the sample container, it still cannot detect the dirt on the inner wall of the sample container in time. In addition, in case of the cleaning brush being disposed on the ultrasonic conduction rod, the wire between the ultrasonic generation unit and the ultrasonic conduction rod is entangled due to the driving motor driving the cleaning brush to rotate, resulting in the continuous operation of the driving motor, but the cleaning brush can't continue to rotate.

In view of the deficiencies of the prior art, this disclosure proposes a contamination detection device, an automatic cleaning device, a contamination detection and auto-cleaning equipment and a method using the same, which could be capable of improving the aforementioned conventional problems.

According to ab embodiment of the disclosure, a contamination detection device for detecting a cleanliness of a sample container is provided. The contamination detection device includes a light emitter, a detection-light receiver and a controller. The light emitter is located at a light incident side of the sample container, and configured to emit an emission light, wherein the emission light becomes a detection light after traveling through the sample container. The detection-light receiver is located at a position opposite to the light emitter, wherein the position is at a light output side of the sample container, and the detection-light receiver is configured to receive the detection light to obtain a detection-light intensity. The controller is coupled to the light emitter and the detection-light receiver and configured to obtain a cleanliness of the sample container according to a variation of the detection-light intensity.

According to another embodiment of the disclosure, an automatic cleaning device for cleaning a sample container is provided. The automatic cleaning device includes an ultrasonic generation unit, a hollow sleeve, an ultrasonic conduction rod and a cleaning brush component. The ultrasonic generation unit is configured to generate an oscillation with an ultrasonic frequency. The ultrasonic conduction rod is connected to the ultrasonic generation unit, which is located in the hollow sleeve. The ultrasonic conduction rod is configured to conduct the oscillation to a test liquid that is to be measured within the sample container. The cleaning brush component is connected to the hollow sleeve and configured to clean an inner wall of the sample container.

According to another embodiment of the disclosure, a contamination detection and auto-cleaning equipment is provided. The contamination detection and auto-cleaning equipment includes the contamination detection device as mentioned above, the automatic cleaning device as mentioned above and the controller as mentioned above. The controller is coupled to the light emitter, the detection-light receiver and the automatic cleaning device, and configured to: control the light emitter to emit the emission light; obtain the cleanliness of the sample container according to the variation of the detection-light intensity; and when the cleanliness is lower than a predetermined value, control the automatic cleaning device to clean the sample container.

According to another embodiment of the disclosure, a contamination detection method for detecting a cleanliness of a sample container includes the following steps: emitting an emission light by a light emitter, wherein the emission light becomes a detection light after traveling through the sample container; receiving the detection light for obtaining a detection-light intensity by a detection-light receiver; and obtaining the cleanliness of the sample container according to a variation of the detection-light intensity.

According to another embodiment of the disclosure, an automatic cleaning method for cleaning a sample container includes the following steps: generating an oscillation with a ultrasonic frequency by an ultrasonic generation unit, wherein the oscillation is conducted to a test liquid that is to be measured within the sample container through an ultrasonic conduction rod; and cleaning an inner wall of the sample container by a cleaning brush component.

According to another embodiment of the disclosure, a contamination detection and auto-cleaning method for detecting a cleanliness of a sample container includes the following steps: receiving the detection light which travels through the sample container for obtaining a detection-light intensity; obtaining the cleanliness of the sample container according to a variation of the detection-light intensity; and when the cleanliness is lower than a predetermined value, controlling an automatic cleaning device to clean the sample container so that the cleanliness is higher the predetermined value.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a functional block diagram of a contamination detection and auto-cleaning equipment according to an embodiment of the present disclosure;

FIGS. 2A to 2B show schematic diagrams of the appearances of the contamination detection and auto-cleaning equipment in FIG. 1 at different viewing angles;

FIG. 2C shows a schematic diagram of an appearance of the cleaning rod in FIG. 2A;

FIG. 3 shows a flow chart of a contamination detection and auto-cleaning method of the contamination detection and auto-cleaning equipment in FIG. 1 according to an embodiment of the present disclosure; and

FIGS. 4A to 4C illustrate a flow chart of a contamination detection and auto-cleaning method of the contamination detection and auto-cleaning equipment in FIG. 1 according to another embodiment of the present disclosure.

### DETAILED DESCRIPTION

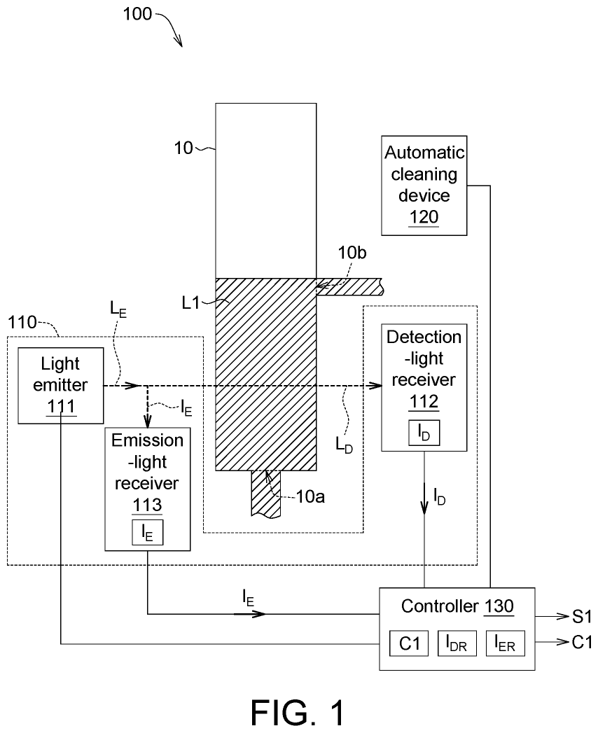

Referring to FIG. 1, FIG. 1 shows a functional block diagram of a contamination detection and auto-cleaning equipment 100 according to an embodiment of the present disclosure. The contamination detection and auto-cleaning equipment 100 includes a contamination detection device 110, an automatic cleaning device (also known as an auto-cleaning device) 120 and a controller 130. The controller 130 is coupled to the contamination detection device 110 and the automatic cleaning device 120. In another embodiment, the controller 130 may be disposed on the contamination detection device 110.

The contamination detection device 110 is configured to detect a cleanliness C1 of the sample container 10. The contamination detection device 110 includes a light emitter 111, a detection-light receiver 112 and a emission-light receiver 113. The light emitter 111 is located at a light incident side of a sample container 10 and configured to emit an emission light L_{E}, and the emission light L_{E} becomes a detection light L_{D} after the emission light L_{E} travels through the sample container 10. The detection-light receiver 112 is located at a position opposite to the light emitter 111, the position is at an light output side of the sample container 10, and configured for receiving the detection light L_{D} to obtain a detection-light intensity I_{D}. The controller 130 is coupled to the light emitter 111 and the detection-light receiver 112 and configured to obtain the cleanliness C1 of the sample container 10 according to a variation of the detection-light intensity I_{D}.

The emission-light receiver 113 is coupled to the controller 130, located at the light incident side of the sample container 10, and configured for receiving the emission light L_{E} to obtain an emission-light intensity I_{E}. The cleanliness C1 of the sample container 10 is obtained according to variations of the detection-light intensity I_{D} and the emission-light intensity I_{E}. When the detection-light intensity I_{D} becomes weaker (possibly resulted from the cleanliness C1 of the sample container 10 becomes weaker or the emission-light intensity I_{E} becomes weaker), the cleanliness C1 of the sample container 10 becomes worse. By detecting the variation of the detection-light intensity I_{D}, the cleanliness C1 of the sample container 10 could be known (or obtained). The aforementioned cleanliness C1 is, for example, the cleanliness of the inner wall of the sample container 10.

The controller 130 is configured to compensate an error between an emission-light reference intensity I_{ER} and the emission-light intensity I_{E} to obtain the cleanliness C1 of the sample container 10 according to the emission-light reference intensity I_{ER}, or correct the emission-light intensity I_{E} lose to the emission-light reference intensity I_{ER} to reduce the error before compensating.

The cleanliness C1 is obtained according to the following formula (1), wherein IDR represents a detection-light reference intensity, and I_{ER} represents the emission-light reference intensity.

$$C 1 = \frac{{I}_{D}}{{I}_{DR}} \times \frac{{I}_{ER}}{{I}_{E}} \qquad ( 1 )$$

The detection-light reference intensity I_{DR} and the emission-light reference intensity I_{ER} could be used as a basis for calculating the cleanliness of the sample container. In an embodiment, the detection-light reference intensity I_{DR} and the emission-light reference intensity I_{ER} are obtained by: after injecting deionized water into a clean new sample container and turning on the emission light L_{E}, the light intensities detected by the detection-light receiver 112 and the emission-light receiver 113 are the detection-light reference intensity I_{DR} and the emission-light reference intensity I_{ER} respectively. In addition, the detection-light reference intensity I_{DR} and the emission-light reference intensity I_{ER} could be pre-stored in a memory (not shown) or in the controller 130.

The emission-light reference intensity I_{ER} and the emission-light intensity I_{E} could be used as compensation for the light emitter 111. Furthermore, when the emission light L_{E} of the light emitter 111 is weakened, the obtained (or detected) cleanliness C1 of the sample container 10 will be inaccurate. However, through the compensation amount (I_{ER}/I_{E}) composed of the emission-light reference intensity I_{ER} and the emission-light intensity I_{E}, an error caused by the weakening of the emission light L_{E} emitted by the light emitter 111 itself could be compensated. Before compensation, the light emitter 111 could be corrected if necessary. For example, before compensation, the controller 130 could automatically adjust the parameters of the light emitter 111 (for example, driving current), and directly correct the emission light L_{E} to a value enough close to the emission-light reference intensity I_{ER} for reducing the error in the compensation correction formula.

In another embodiment, the contamination detection device 110 could omit the emission-light receiver 113. The light emitter 111 could have a self-calibration function, so the error caused by unstable light source intensity could be avoided or reduced. The cleanliness C1 of the sample container 10 could be obtained according to the variation of the detection-light intensity I_{D}, for example, according to the following formula (2). In the present embodiment, the controller 130 is configured to compensate an error between an detection-light reference intensity I_{DR} and the detection-light intensity I_{D} to obtain the cleanliness C1 of the sample container 10 according to the detection-light reference intensity I_{DR}, or correct the detection-light intensity I_{D} to approach the detection-light reference intensity IDR to reduce the error before compensating.

$$C 1 = \frac{{I}_{D}}{{I}_{DR}} \qquad ( 2 )$$

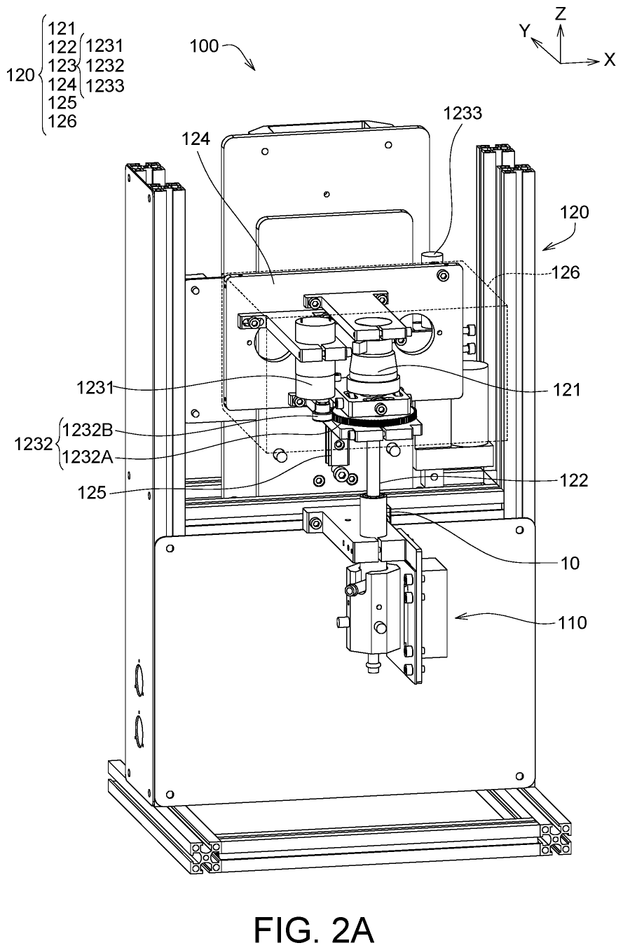

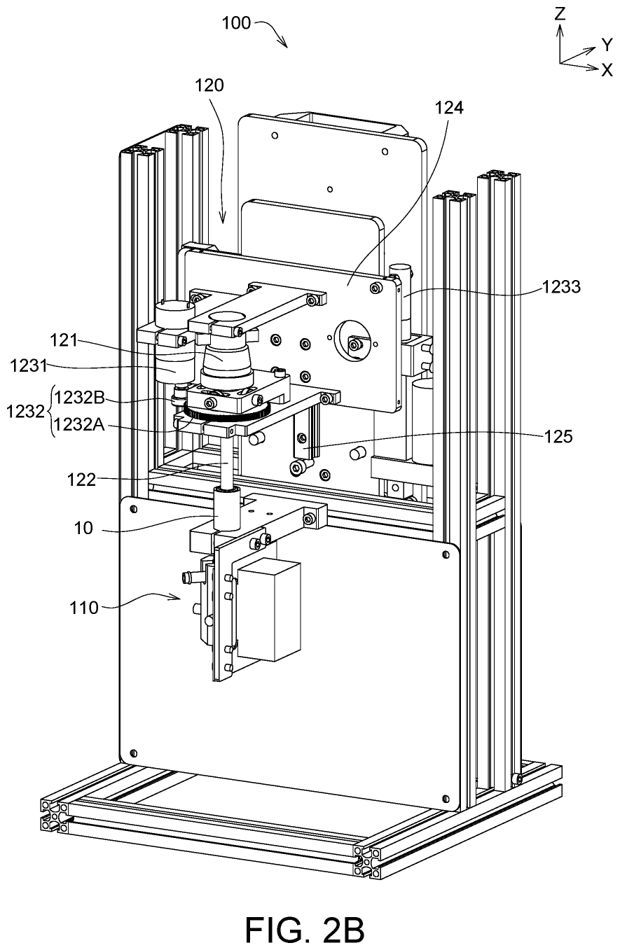

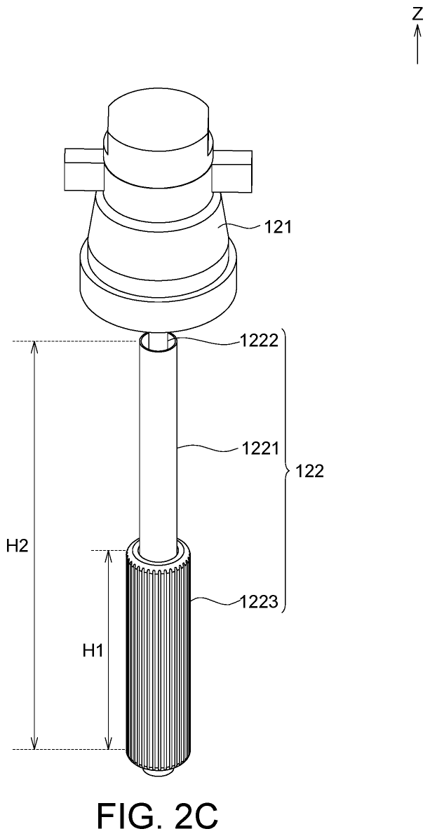

Referring to FIGS. 2A to 2C, FIGS. 2A to 2B show schematic diagrams of the appearances of the contamination detection and auto-cleaning equipment 100 in FIG. 1 at different viewing angles, and FIG. 2C shows a schematic diagram of an appearance of the cleaning rod 122 in FIG. 2A. The automatic cleaning device 120 of the contamination detection and auto-cleaning equipment 100 could clean the sample container 10. The automatic cleaning device 120 includes an ultrasonic generation unit 121, a cleaning rod 122, a driving device 123, a carrier plate 124, a sliding rail 125 and a box 126.

As shown in FIGS. 2A to 2C, the ultrasonic generation unit 121 could be connected to the carrier plate 124. The ultrasonic generation unit 121 is, for example, an oscillator and could generate an oscillation with an ultrasonic frequency. The cleaning rod 122 includes a hollow sleeve 1221, an ultrasonic conduction rod 1222 and a cleaning brush 1223. The ultrasonic conduction rod 1222 is connected to the ultrasonic generation unit 121, located in the hollow sleeve 1221, and configured for conducting the oscillation to a test liquid L1 that is to be measured to clean the sample container 10. The test liquid L1 that is to be measured here is, for example, river water, reservoir water, water-tower water, waste water, sewage, ditch water, discharge water, fish-farm water or other liquid that need to be detected.

As shown in FIGS. 2A to 2C, the cleaning brush 1223 is connected to the hollow sleeve 1221 and configured for cleaning the inner wall of the sample container 10. The cleaning brush component 1223 includes a plurality of brushes, each brush has a length of, for example, 0.5 centimeter (cm), shorter or longer. The hollow sleeve 1221 is, for example, made of metal, such as stainless steel. The hollow sleeve 1221 has a thickness of, for example, 0.4 cm and an inner diameter of is, for example, 1 cm. The cleaning brush component 1223 has a first length H1 (for example, in the Z axis), the hollow sleeve 1221 has a second length H2 (for example, in the Z axis), a ratio of the first length H1 to the second length H2 ranges, for example, between 0.1 to 0.9. In an embodiment, the first length H1 is, for example, 8 cm, and the second length H2 is, for example, 18 cm. The illustrated Z axis is, for example, a long-axis direction of the sample container 10.

As shown in FIGS. 2A to 2C, the driving device 123 could drive the cleaning rod 122 to work. The driving device 123 includes a first driver 1231, a driving mechanism 1232 and a second driver 1233. The driving mechanism 1232 connects the hollow sleeve 1221 with the first driver 1231. The first driver 1231 could drive the mechanism 1232 to rotate for driving the hollow sleeve 1221 to rotate, and then drive the cleaning brush component 1223 to rotate to clean the sample container 10. In an embodiment, the first driver 1231 is, for example, a motor, and the driving mechanism 1232 is, for example, a gear set. The driving mechanism 1232 includes a first gear 1232A and a second gear 1232B meshed with the first gear 1232A, the first gear 1232A is fixed to the hollow sleeve 1221, and the second gear 1232B is fixed to a transmission shaft of the first driver 1231. As a result, the first driver 1231 could drive the second gear 1232B to rotate for driving the first gear 1232A to rotate, and then drive the hollow sleeve 1221 to rotate.

As shown in FIGS. 2A to 2C, the driving device 123 could be disposed on the carrier plate 124 to move with the carrier plate 124. The carrier plate 124 is connected in a translational manner relative to the sliding rail 125, for example, in the Z axis. The second driver 1233 is connected to the carrier plate 124 and configured to drive the carrier plate 124 to translate relative to the sliding rail 125. The second driver 1233 is, for example, a fluid driver, such as an oil cylinder assembly or an air cylinder assembly. The aforementioned ultrasonic generation unit 121, cleaning rod 122 and driving device 123 could be disposed on the carrier plate 124 to translate with the carrier plate 124. As a result, when the support plate 124 translates, the cleaning rod 122 could translate in the Z axis (up and down) to clean the sample container 10 in the Z axis. In addition, the sliding rail 125 could be fixed to a fixed frame of the automatic cleaning device 120. The box 126 could be fixed to the carrier plate 124 and cover the ultrasonic generation unit 121, a portion of the cleaning rod 122 and a portion of the driving device 123, and moves with the carrier plate 124.

As shown in FIGS. 2A to 2C, the controller 130 (shown in FIG. 1) could control the first driver 1231 to drive the cleaning brush component 1223 to rotate to clean the inner wall of the sample container 10. The controller 130 could control the second driver 1233 to drive the cleaning brush component 1223 to translate up and down for cleaning the inner wall of the sample container 10. In an embodiment, the controller 130 could simultaneously control the first driver 1231 and the second driver 1233 to drive the cleaning brush component 1223 to rotate and translate up and down simultaneously. In another embodiment, at a time point, the controller 130 may control the cleaning brush component 1223 to perform only one of a rotation movement and an up-and-down translation movement.

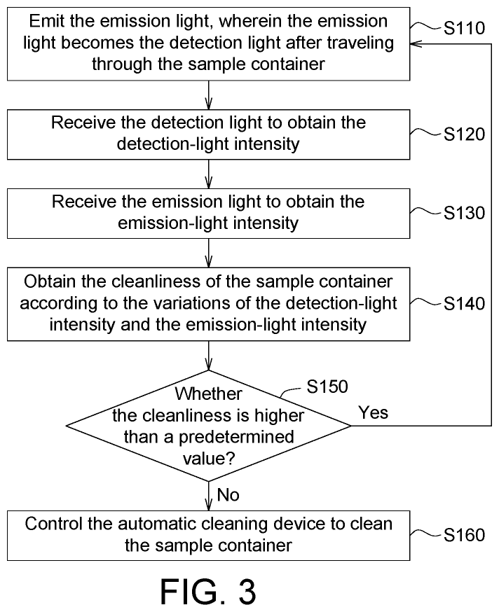

Referring to FIG. 3, FIG. 3 shows a flow chart of a contamination detection and auto-cleaning method of the contamination detection and auto-cleaning equipment 100 in FIG. 1 according to an embodiment of the present disclosure.

In step S110, the controller 130 controls the light emitter 111 to emit the emission light L_{E}, wherein the emission light L_{E} becomes the detection light L_{D} after traveling through the sample container 10.

In step S120, the detection-light receiver 112 receives the detection light L_{D} to obtain the detection-light intensity I_{D}. The information of the detection-light intensity I_{D} could be transmitted to the controller 130.

In step S130, the emission-light receiver 113 receives the emission light L_{E} to obtain the emission-light intensity I_{E}. The information of the emission-light intensity I_{E} could be transmitted to the controller 130.

In step S140, the controller 130 obtains the cleanliness C1 of the sample container 10 according to the variations of the detection-light intensity I_{D} and the emission-light intensity I_{E}. In an embodiment, the controller 130 could use the above formula (1) to obtain the cleanliness C1 of the sample container 10.

In step S150, the controller 130 determines whether the cleanliness C1 is higher than a predetermined value. If yes, the process returns to step S110 to continue the cleanliness calculation in the next sampling. If not, the process proceeds to step S160. The aforementioned predetermined value is, for example, a real number ranges between 0.95 and 0.99, but it could also be higher or lower.

In step S160, the controller 130 could control the automatic cleaning device 120 to clean the sample container 10. For example, the controller 130 could control the ultrasonic generation unit 121 to oscillation with ultrasonic frequency. The ultrasonic conduction rod 1222 could conduct the oscillation to the test liquid L1 that is to be measured in the sample container 10 for cleaning the sample container 10. Then, the controller 130 could control the cleaning brush component 1223 to clean the inner wall of the sample container 10. At a time point, the controller 130 could control the cleaning brush component 1223 to perform at least one of the rotation movement and the translational movement. The embodiment of the present disclosure does not limit the motion mode (for example, an operating time, a speed, an action sequence, etc.) of the cleaning brush component 1223. In an embodiment, the cleaning brush component 1223 and the ultrasonic generation unit 121 could operate simultaneously. In addition, the present disclosed embodiment does not limit the motion modes (for example, an operating time, a speed, an action sequence, etc.) of the cleaning brush component 1223 and the ultrasonic wave generation unit 121. In addition, an action schedule of the cleaning brush component 1223 and the ultrasonic generation unit 121 could be set in a user interface.

In another embodiment, when the contamination detection device 110 omits the emission-light receiver 113, the process in FIG. 3 could omit step S130 and step S140 could be adjusted to: the controller 130 obtains the cleanliness C1 of the sample container 10 according to the variation of the detection-light intensity I_{D}.

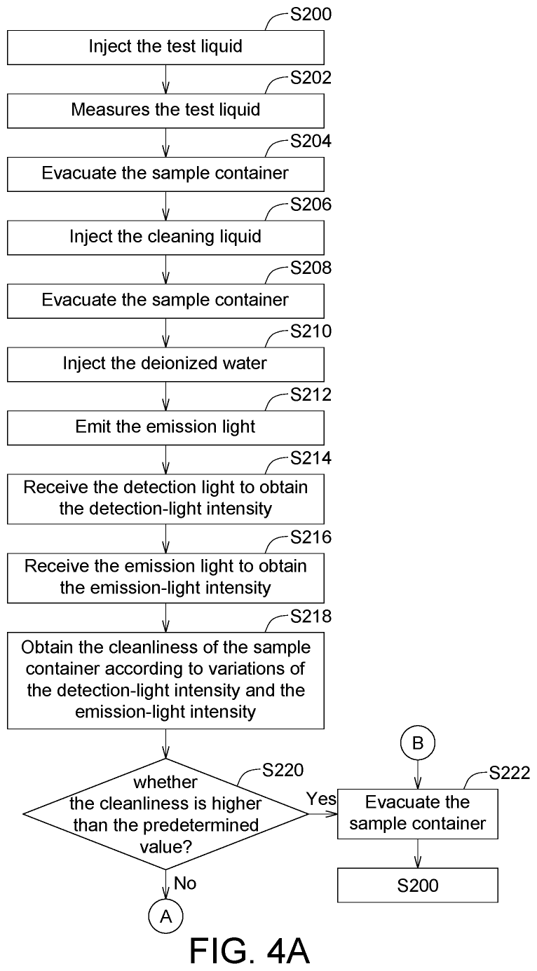

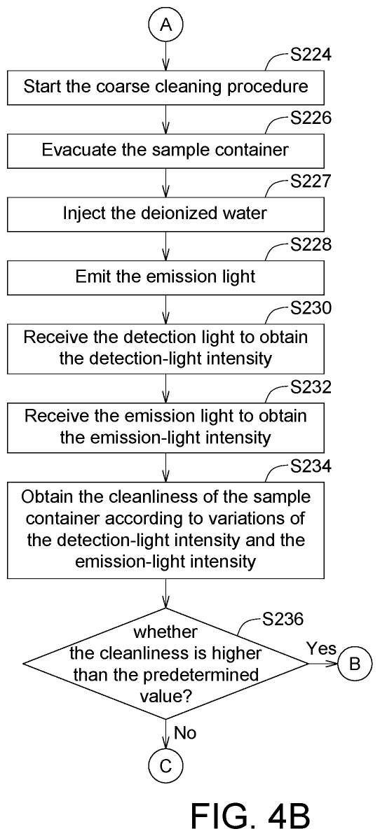

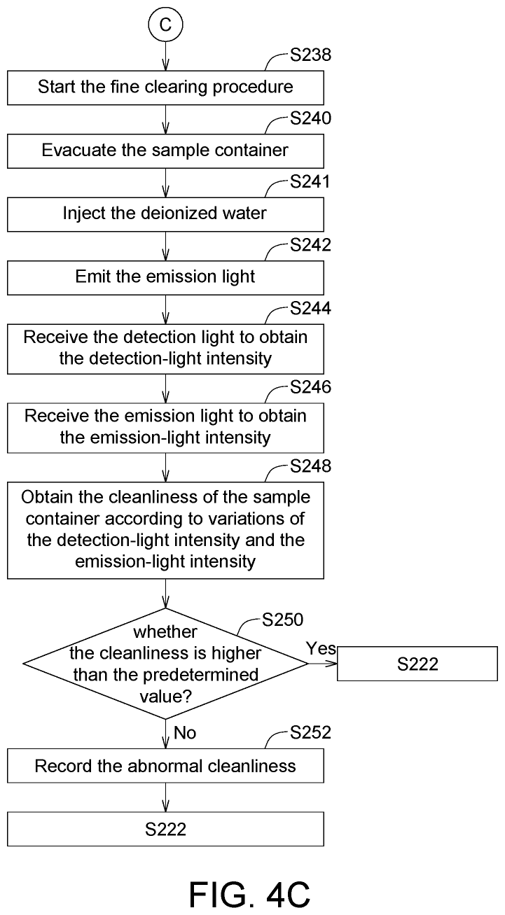

Referring to FIGS. 4A to 4C, FIGS. 4A to 4C illustrate a flow chart of a contamination detection and auto-cleaning method of the contamination detection and auto-cleaning equipment 100 in FIG. 1 according to another embodiment of the present disclosure. Before the process is executed, the detection-light reference intensity IDR and the emission-light reference intensity I_{ER} could be obtained in advance.

In step S200, the test liquid L1 that is to be measured is injected into the sample container 10. For example, the controller 130 controls a pump (not shown) to inject the test liquid L1 that is to be measured into the sample container 10 from a first opening 10a (the first opening 10a is shown in FIG. 1) of the sample container 10.

In step S202, a sensor (not shown) measures the characteristics of the test liquid L1 that is to be measured, for example, a temperature, a pH value, a conductivity, a chromaticity, a turbidity, a total dissolved solids concentration, a suspended solids concentration, a chemical demand oxygen concentration, a total organic carbon concentration, a nitrate nitrogen concentration or a parameter representing other characteristics of the test liquid L1 that is to be measured.

In step S204, the sample container 10 is evacuated. For example, the controller 130 controls a pump (not shown) to discharge the test liquid L1 that is to be measured within the sample container 10 through a second opening 10b of the sample container 10 (the second opening 10b is shown in FIG. 1) out of the sample container 10. In the present embodiment, the first opening 10a is an inlet, and the second opening 10b is an outlet. However, in another embodiment, the first opening 10a could be the outlet, and the second opening 10b could be the inlet.

In step S206, a cleaning liquid (not shown) is injected. For example, the controller 130 controls a pump (not shown) to inject the cleaning liquid into the sample container 10 through the first opening 10a of the sample container 10. The cleaning liquid is, for example, clear water, hydrogen peroxide, microbubble water, ozone water or a combination thereof.

In step S208, the sample container 10 is evacuated. For example, the controller 130 controls a pump (not shown) to discharge the cleaning liquid in the sample container 10 out of the sample container 10 through the second opening 10b of the sample container 10.

In step S210, the deionized water (not shown) is injected. For example, the controller 130 could control a pump (not shown) to inject the deionized water into the sample container 10 through the first opening 10a of the sample container 10.

Then, the controller 130 executes a contamination detection procedure (steps S212 to S218).

In step S212, the controller 130 controls the light emitter 111 to emit the emission light L_{E}.

In step S214, the detection-light receiver 112 receives the detection light L_{D} to obtain the detection-light intensity I_{D}. The information of detection-light intensity I_{D} could be transmitted to the controller 130.

In step S216, the detection-light receiver 112 receives the emission light L_{E} to obtain the emission-light intensity I_{E}. The information of the emission-light intensity I_{E} could be transmitted to the controller 130.

In an embodiment, the light emitter 111 emits the emission light L_{E} for a period of time, stops emitting the emission light L_{E} after the detection-light receiver 112 receives the detection light L_{D} and the emission-light receiver 113 receives the emission light L_{E}. Then, the controller 130 controls the light emitter 111 to emit the emission light L_{E} in the next contamination detection.

In step S218, the controller 130 could obtain the cleanliness C1 of the sample container 10 according to the detection-light intensity I_{D} and the emission-light intensity I_{E}. In an embodiment, the controller 130 could obtain the cleanliness C1 of the sample container 10 by using the above formula (1).

In step S220, the controller 130 determines whether the cleanliness C1 is higher than the predetermined value. If not, the process proceeds to step S224. If yes, the process proceeds to step S222.

In step S222, the sample container 10 is evacuated. For example, the controller 130 controls a pump (not shown) to discharge the deionized water within the sample container 10 out of the sample container 10 through the second opening 10b of the sample container 10. Then, the process returns to step S200 for the measurement for the next test liquid L1 that is to be measured.

In step S224, the controller 130 starts a coarse cleaning procedure. For example, the automatic cleaning device 120 controls the cleaning rod 122 to clean the sample container 10 without the ultrasonic oscillation. In another embodiment, the ultrasonic generation unit 121 and the cleaning rod 122 could also operate simultaneously. After the cleaning is completed, the process proceeds to step S226.

In step S226, the sample container 10 is evacuated. For example, the controller 130 controls a pump (not shown) to discharge the deionized water within the sample container 10 out of the sample container 10 through the second opening 10b of the sample container 10.

In step S227, the deionized water is injected. For example, the controller 130 could control a pump (not shown) to inject the deionized water into the sample container 10 through the first opening 10a of the sample container 10.

Then, the controller 130 executes the contamination detection procedure (steps S228 to S234).

In step S228, the controller 130 controls the light emitter 111 to emit the emission light L_{E}.

In step S230, the detection-light receiver 112 receives the detection light L_{D} to obtain the detection-light intensity I_{D}. The information of the detection-light intensity I_{D} could be transmitted to the controller 130.

In step S232, the emission-light receiver 113 receives the emission light L_{E} to obtain the emission-light intensity I_{E}. The information of the emission-light intensity I_{E} could be transmitted to the controller 130.

In an embodiment, the light emitter 111 emits the emission light L_{E} for a period of time, and stops emitting the emission light L_{E} after the detection-light receiver 112 receives the detection light L_{D} and the emission-light receiver 113 receives the emission light L_{E}. Then, the controller 130 controls the light emitter 111 to emit the emission light L_{E} in the next contamination detection.

In step S234, the controller 130 obtains the cleanliness C1 of the sample container 10 according to the variations of the detection-light intensity I_{D} and the emission-light intensity I_{E}. In an embodiment, the controller 130 could obtain the cleanliness C1 of the sample container 10 by using the above formula (1).

In step S236, the controller 130 determines whether the cleanliness C1 is higher than the predetermined value. If yes, the process proceeds to step S222. If not, the process proceeds to step S238.

In step S238, the controller 130 starts a fine clearing procedure. For example, the ultrasonic generation unit 121 and the cleaning rod 122 could operate at the same time, and the operating time is longer than that of the aforementioned coarse cleaning procedure. After the cleaning is completed, the process proceeds to step S240.

In step S240, the sample container 10 is evacuated. For example, the controller 130 controls a pump (not shown) to discharge the deionized water within the sample container 10 out of the sample container 10 through the second opening 10b of the sample container 10.

In step S241, the deionized water is injected. For example, the controller 130 could control a pump (not shown) to inject the deionized water into the sample container 10 from the first opening 10a of the sample container 10.

Then, the controller 130 executes the contamination detection process (steps S242 to S248).

In step S242, the controller 130 controls the light emitter 111 to emit the emission light L_{E}.

In step S244, the detection-light receiver 112 receives the detection light LD to obtain the detection-light intensity I_{D}. The information of the detection-light intensity I_{D} could be transmitted to the controller 130.

In step S246, the emission-light receiver 113 receives the emission light L_{E} to obtain the emission-light intensity I_{E}. The information of the emission-light intensity I_{E} could be transmitted to the controller 130.

In an embodiment, the light emitter 111 emits the emission light L_{E} for a period of time, and stops emitting the emission light L_{E} after the detection-light receiver 112 receives the detection light L_{D} and the emission-light receiver 113 receives the emission light L_{E}. Then, the controller 130 controls the light emitter 111 to emit the emission light L_{E} in the next contamination detection.

In step S248, the controller 130 obtains the cleanliness C1 of the sample container 10 according to the variations of the detection-light intensity I_{D} and the emission-light intensity I_{E}. In an embodiment, the controller 130 could obtain the cleanliness C1 of the sample container 10 by using the above formula (1).

In step S250, the controller 130 determines whether the cleanliness C1 is higher than the predetermined value. If not, it means that the sample container 10 still cannot conform to (or satisfy) the cleanliness higher than the predetermined value after the coarse cleaning procedure and the fine cleaning procedure, and it is regarded as an abnormal situation, so the controller 130 records the abnormal cleanliness C1 (step S252), and then the process proceeds to step S222. If yes, it means that the sample container 10 has conformed to (or satisfied) a cleanliness level equal to or higher than the predetermined value after the coarse cleaning procedure and the fine cleaning procedure, so the process proceeds to step S222 for the measurement for the next test liquid L1 that is to be measured.

In an embodiment, when abnormality is detected twice in a row, the controller 130 could transmit a maintenance notification S1 (the maintenance notification S1 is shown in FIG. 1). In addition, as long as the cleanliness C1 is obtained (the cleanliness C1 is shown in FIG. 1), the controller 130 could transmit the cleanliness C1. An external electronic device (for example, a server) could receive the maintenance notification S1 and the cleanliness C1 and record such information.

In another embodiment, when the contamination detection device 110 omits the emission-light receiver 113, the process of FIGS. 4A to 4C could omit steps S216, S232 and S246, and step S218, S234 and S248 could be adjusted to: the controller 130 obtains the cleanliness C1 of the sample container 10 according to the variation of the detection-light intensity I_{D}.

As shown in Table 1 below, the no-cleaning group means that the sample container 10 is not cleaned, and the regular cleaning group means that the sample container 10 is cleaned regularly (but the cleanliness is not detected). In contrast, since the contamination detection and auto-cleaning equipment 100 could automatically detect the cleanliness C1 of the sample container 10 and could automatically and immediately clean the sample container 10 when the detected cleanliness of the sample container 10 is not as expected, it could achieve at least one of a plurality of technical effects: (1). the drop of the detection-light intensity is small when the deionized water is repeatedly measured; (2). high cleanliness C1 could be maintained; and (3). the turbidity zero offset is low when the deionized water is repeatedly measured.

TABLE 1

| | | regular | contamination |
|---|---|---|---|
| | no- | cleaning | detection and |
| | cleaning | control | auto-cleaning |
| | group | group | equipment 100 |
| drop of the detection-light | 225 | 9 | 2 |
| intensity (mV) | | | |
| cleanliness C1(%) | 56.0 | 98.5 | 99.4 |
| turbidity zero offset (NTU) | 752 | 4.8 | 0.1 |

To sum up, an embodiment of the present disclosure discloses a contamination detection and auto-cleaning equipment combined with a contamination detection device and an automatic cleaning device, and a method using the same, which could automatically detect the cleanliness of the sample container. The contamination detection and auto-cleaning equipment could automatically clean the sample container when the detected cleanliness of the sample container is not as expected.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A contamination detection device for detecting a cleanliness of a sample container, comprising:
a light emitter located at a light incident side of the sample container, and configured to emit an emission light, wherein the emission light becomes a detection light after traveling through the sample container;
a detection-light receiver located at a position opposite to the light emitter, wherein the position is at a light output side of the sample container, and the detection-light receiver is configured to receive the detection light to obtain a detection-light intensity; and
a controller coupled to the light emitter and the detection-light receiver and configured to obtain a cleanliness of the sample container according to a variation of the detection-light intensity.

2. The contamination detection device according to claim 1, further comprising:
an emission-light receiver coupled to the controller, located at a light incident side of the sample container, and configured to receive the emission light to obtain an emission-light intensity;
the controller configured to compensate an error between an emission-light reference intensity and the emission-light intensity to obtain the cleanliness of the sample container according to the emission-light reference intensity, or correct the emission-light intensity to approach the emission-light reference intensity to reduce the error before compensating.

3. An automatic cleaning device for cleaning a sample container, comprising:
an ultrasonic generation unit configured to generate an oscillation with an ultrasonic frequency;
a hollow sleeve;
an ultrasonic conduction rod connected to the ultrasonic generation unit, located in the hollow sleeve, and configured to conduct the oscillation to a test liquid that is to be measured within the sample container; and
a cleaning brush component disposed on the hollow sleeve and configured to clean an inner wall of the sample container.

4. The automatic cleaning device according to claim 3, further comprising:
a first drive; and
a driving mechanism connecting the hollow sleeve with the first driver;
wherein the driving mechanism comprises a first gear and a second gear meshed with the first gear, the first gear is fixed to the hollow sleeve, and the second gear is fixed to a transmission shaft of the first driver.

5. The automatic cleaning device according to claim 3, further comprising:
a sliding rail;
a carrier plate translatably disposed relative to the sliding rail;
a second driver connected to the carrier plate and configured to drive the carrier plate to translate relative to the sliding rail;
wherein the hollow sleeve, the ultrasonic generation unit, the ultrasonic conduction rod and the cleaning brush component are disposed on the carrier plate.

6. A contamination detection and auto-cleaning equipment, comprising:
a contamination detection device for detecting a cleanliness of a sample container, comprising:
a light emitter located at a light incident side of the sample container, and configured to emit an emission light, wherein the emission light becomes a detection light after traveling through the sample container;
a detection-light receiver located at a position opposite to the light emitter, the position is at an light output side of the sample container, and configured to receive the detection light to obtain a detection-light intensity; and
a controller coupled to the light emitter and the detection-light receiver and configured to obtain a cleanliness of the sample container according to a variation of the detection-light intensity;
an automatic cleaning device for cleaning the sample container, comprising:
an ultrasonic generation unit located at a configured to generate an oscillation with an ultrasonic frequency;
a hollow sleeve;
an ultrasonic conduction rod connected to the ultrasonic generation unit, located in the hollow sleeve, and configured to conduct the oscillation to a test liquid that is to be measured within the sample container; and
a cleaning brush component disposed on the hollow sleeve and configured to clean an inner wall of the sample container; and
the controller coupled to the light emitter, the detection-light receiver and the automatic cleaning device, and configured to:
control the light emitter to emit the emission light;
obtain the cleanliness of the sample container according to the variation of the detection-light intensity; and
when the cleanliness is lower than a predetermined value, control the automatic cleaning device to clean the sample container.

7. The contamination detection and auto-cleaning equipment according to claim 6, wherein the contamination detection device further comprises:
an emission-light receiver coupled to the controller, located at a light incident side of the sample container, and configured to receive the emission light to obtain an emission-light intensity; and
the controller further configured to compensate an error between an emission-light reference intensity and the emission-light intensity to obtain the cleanliness of the sample container according to the emission-light reference intensity, or correct the emission-light intensity to approach the emission-light reference intensity to reduce the error before compensating.

8. The contamination detection and auto-cleaning equipment according to claim 6, further comprises:
a first drive; and
a driving mechanism connecting the hollow sleeve with the first driver;
wherein the driving mechanism comprises a first gear and a second gear meshed with the first gear, the first gear is fixed to the hollow sleeve, and the second gear is fixed to a transmission shaft of the first driver.

9. The contamination detection and auto-cleaning equipment according to claim 6, further comprising:
a sliding rail;
a carrier plate translatably disposed relative to the sliding rail;
a second driver connected to the carrier plate and configured to drive the carrier plate to translate relative to the sliding rail;
wherein the hollow sleeve, the ultrasonic generation unit, the ultrasonic conduction rod and the cleaning brush component are disposed on the carrier plate.

10. A contamination detection method for detecting a cleanliness of a sample container, comprising:
emitting an emission light by a light emitter, wherein the emission light becomes a detection light after traveling through the sample container;
receiving the detection light for obtaining a detection-light intensity by a detection-light receiver; and
obtaining the cleanliness of the sample container according to a variation of the detection-light intensity.

11. The contamination detection method according to claim 10, further comprising:
receiving the emission light for obtaining an emission-light intensity by an emission-light receiver;
step of obtaining the cleanliness of the sample container according to the variation of the detection-light intensity further comprises:
compensating an error between an emission-light reference intensity and the emission-light intensity to obtain the cleanliness of the sample container according to the emission-light reference intensity, or correcting the emission-light intensity to approach the emission-light reference intensity to reduce the error before compensating.

12. The contamination detection method according to claim 11, wherein the cleanliness C1 is obtained according to the following formula (1):
$$C 1 = \frac{{I}_{D}}{{I}_{DR}} \times \frac{{I}_{ER}}{{I}_{E}} ; \qquad ( 1 )$$
wherein I_{D} represents the detection-light intensity, I_{DR} represents a detection-light reference intensity, I_{E} represents the emission-light intensity, and I_{ER} represents an emission-light reference intensity.

13. An automatic cleaning method for cleaning a sample container, comprising:
generating an oscillation with a ultrasonic frequency by an ultrasonic generation unit, wherein the oscillation is conducted to a test liquid that is to be measured within the sample container through an ultrasonic conduction rod; and
cleaning an inner wall of the sample container by a cleaning brush component.

14. The automatic cleaning method according to claim 13, wherein step of cleaning the inner wall of the sample container by the cleaning brush component comprises:
performing at least one of a rotation movement and a translational movement by the cleaning brush component.

15. A contamination detection and auto-cleaning method for detecting a cleanliness of a sample container, comprising:
receiving a detection light which travels through the sample container for obtaining a detection-light intensity;
obtaining the cleanliness of the sample container according to a variation of the detection-light intensity; and
when the cleanliness is lower than a predetermined value, controlling an automatic cleaning device to clean the sample container so that the cleanliness is higher the predetermined value.

16. The contamination detection and auto-cleaning method according to claim 15, further comprising:
receiving an emission light for obtaining an emission-light intensity; and
step of obtaining the cleanliness of the sample container according to the variation of the detection-light intensity further comprises:
compensating an error between an emission-light reference intensity and the emission-light intensity to obtain the cleanliness of the sample container according to the emission-light reference intensity, or correcting the emission-light intensity to approach the emission-light reference intensity to reduce the error before compensating.

17. The contamination detection and auto-cleaning method according to claim 15, wherein step of obtaining the cleanliness of the sample container comprising:
obtaining the cleanliness C1 according to the following formula (1):
$$C 1 = \frac{{I}_{D}}{{I}_{DR}} \times \frac{{I}_{ER}}{{I}_{E}} ; \qquad ( 1 )$$
wherein I_{D} represents the detection-light intensity, I_{DR} represents a detection-light reference intensity, I_{E} represents the emission-light intensity, and I_{ER} represents an emission-light reference intensity.

18. The contamination detection and auto-cleaning method according to claim 15, wherein the automatic cleaning device comprises an ultrasonic generation unit; step of controlling the automatic cleaning device to clean the sample container further comprising:
controlling the ultrasonic generation unit to generate an oscillation with an ultrasonic frequency.

19. The contamination detection and auto-cleaning method according to claim 15, wherein the automatic cleaning device comprises a cleaning brush component; step of controlling the automatic cleaning device to clean the sample container further comprising:
controlling the cleaning brush component to perform at least one of a rotation movement and a translational movement.
